(19) United States
(12) Patent Application Publication
(10) Pub. No.: US 2004/0064533 A1
(43) Pub. Date: Apr. 1, 2004

(54) Loop initialization process for processor

(75) Inventors: Wade B. Tuma, Santa Clara, CA (US); George B. Tuma, Scotts Valley, CA (US)

Correspondence Address: MORRISON & FOERSTER LLP, 755 PAGE MILL RD, PALO ALTO, CA, 94304-1018, US

(73) Assignee: Solid Data Systems Inc.

(21) Appl. No.: 10/256,728

(22) Filed: Sep. 27, 2002

(51) Int. Cl. G06F 15/177

(52) U.S. Cl. 709/222

(57) ABSTRACT

Embodiments of present invention may provide a method, systems and/or computer program products for initializing a data communications loop. This may involve receiving an information frame relating to a loop initialization primitives, determining how many nodes are on the data communications loop and uploading a program having an optimization specific to the number of nodes.

### FIELD OF THE INVENTION

The present invention relates to computer initialization, and more particularly to initialization of multiple intercommunicating computers.

### BACKGROUND OF THE INVENTION

Fibre Channel standards provide computer communications protocols designed to meet the many requirements related to the ever-increasing demand for high performance information transfer. In general, Fibre Channel attempts to combine the benefits of both channel and network technologies which are both well known in the art. The ANSI (American National Standards Institute) Task Group X3.T11 is the authority for the Fibre Channel standards and draft standards. Fibre Channel has made an impact in the storage arena, for example, using SCSI (Small Computer Systems Interface) protocol as an upper layer protocol. The benefits of mapping a SCSI command set onto Fibre Channel over previously developed SCSI implementations include faster speed, more connected devices and larger distances. Fibre Channel may operate in any of Point-to-Point, Arbitrated Loop or Switched Fabric topologies.

Fibre Channel Arbitrated Loop topology provides for a variable number of devices up to a theoretical limit of 127. The number of devices present in a Fibre Channel loop is determined at run time, resulting in complexity and in performance compromises.

Usage of Fibre Channel is commonplace and there are many applications. Usage of Fibre Channel using the Arbitrated Loop topology is also commonplace. Various storage devices with Fibre Channel interfaces are available including disk, tape and semiconductor memories.

The subject invention provides a superior tradeoff between cost, performance, complexity and flexibility in many types of controllers for Fibre Channel loops including, for example, those using SCSI protocols. The invention may also have wider application to other types of computer communication channels and/or networks.

### SUMMARY

According to an embodiment of the invention, a method is provided for initializing a data communications loop. The method may involve receiving an information frame into a processor; determining that the information frame relates to a loop initialization primitive; sending to a second processor; determining a count of nodes on the data communications loop; transferring and executing a program having an optimization specific to the count.

According to a further embodiment of the invention, a system connected to a data communications loop and having two processors is provided for performing the method.

According to a still further embodiment of the invention, a software product is provided for performing the method on a system with two processors.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1A depicts a communication ring conforming to FCA such as may be used to practice an embodiment of the invention.

FIG. 1B depicts an alternative communication ring conforming to FCA such as may be used to practice an embodiment of the invention.

FIG. 2 is a block diagram of a solid state file cache such as may be used to implement procedures according to an embodiment of the present invention.

FIG. 3 shows an exemplary method for initializing a data communications loop according to an aspect of the invention.

FIG. 4 shows an alternative exemplary method for initializing a data communications loop according to an aspect of the invention.

For convenience in description, identical components have been given the same reference numbers in the various drawings.

### DETAILED DESCRIPTION OF THE PREFERRED EMBODIMENTS

In the following description, for purposes of clarity and conciseness of the description, not all of the numerous components shown in the schematics and/or drawings are described. The numerous components are shown in the drawings to provide a person of ordinary skill in the art a thorough, enabling disclosure of the present invention. The operation of many of the components would be understood and apparent to one skilled in the art.

In various embodiments of the invention, structures and methods are provided for initializing processors for loop topology communication rings.

In one embodiment, the present invention provides structures and methods provided for initializing processors for communication rings conforming to FCA (Fibre-Channel Architecture). Fibre-Channel Architecture is well known in the art.

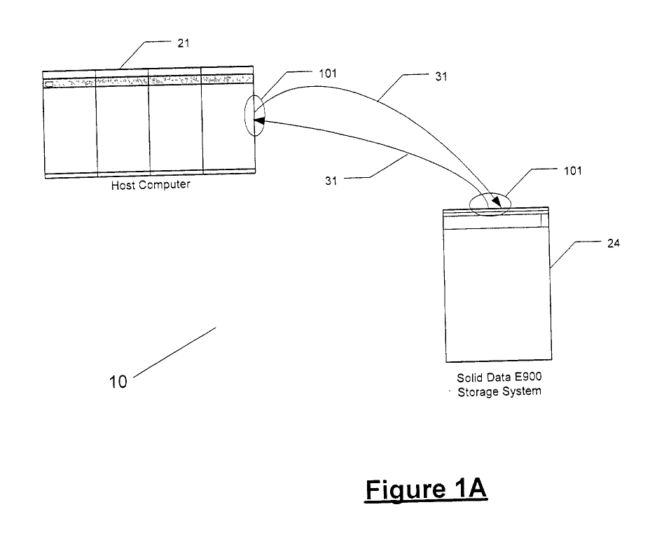

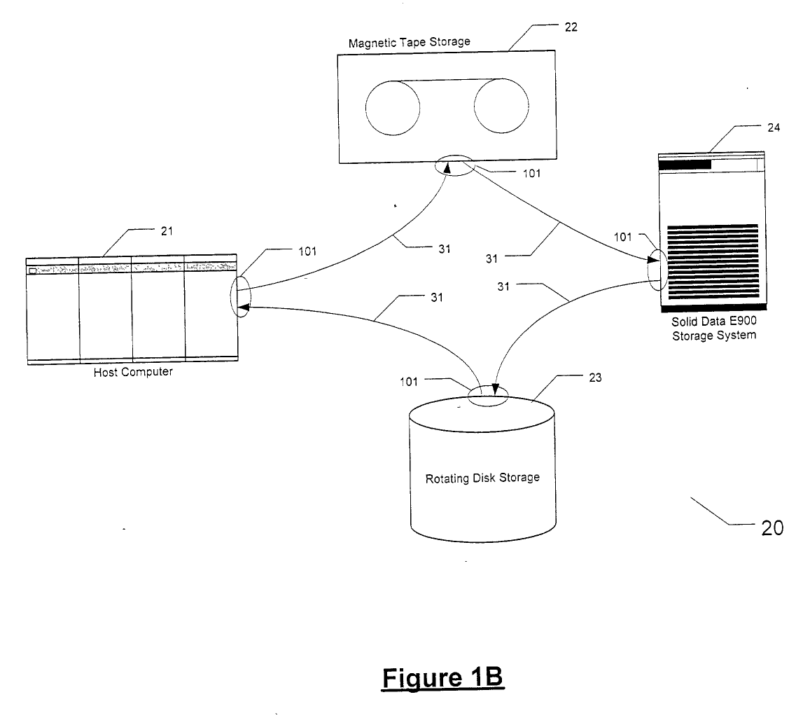

FIG. 1A depicts a simple communication ring 10 conforming to FCA such as may be used to practice an embodiment of the invention. The ring 10 comprises a host computer 21 having a GBIC (Gigabit Interface Converter) circuit 101. Ring 10 also comprises Solid Data® Model E900 Storage System 24 also having a GBIC circuit 101. The storage system 24 may serve as a repository for data and/or software. The two GBIC circuits 101 are adapted to transmit and receive data to and from optical fibers 31. Data transmission in each of the two optical fibers 31 is unidirectional as depicted by the arrowheads in FIG. 1A. Thus, taken together, the two fibers provide for bi-directional high speed data communications between computer 21 and storage system 24. This simple network, having only two nodes, may be operated under FCA point-to-point topology rules or FCA-arbitrated loop topology rules.

FIG. 1B depicts a communication ring 20 conforming to FCA such as may be used to practice an embodiment of the invention. Communication ring 20 may be operating conforming to Arbitrated Loop FCA protocols. The exemplary loop depicted has four nodes—host computer 21, magnetic tape storage device 22, Solid Data® Model E900 Storage System 24, and rotating disk storage device 23. Each of the four nodes 21, 22, 23, 24 may be equipped with at least one GBIC 101 for communicating on the four optical fibers 31 as shown. As before, the arrowheads depicted on the optical fibers 31 may indicate a direction of data flow; thus, it can be seen that the network may operate as a form of unidirectional loop. Some of the nodes 21, 22, 23, 24 may be provided with more than one GBIC (additional GBICs not shown in FIG. 1B) and more than one loop of optical fibers 31 may be present in order to provide fallback redundancy or increased throughput through techniques such as fail-over, striping and others that are well known.

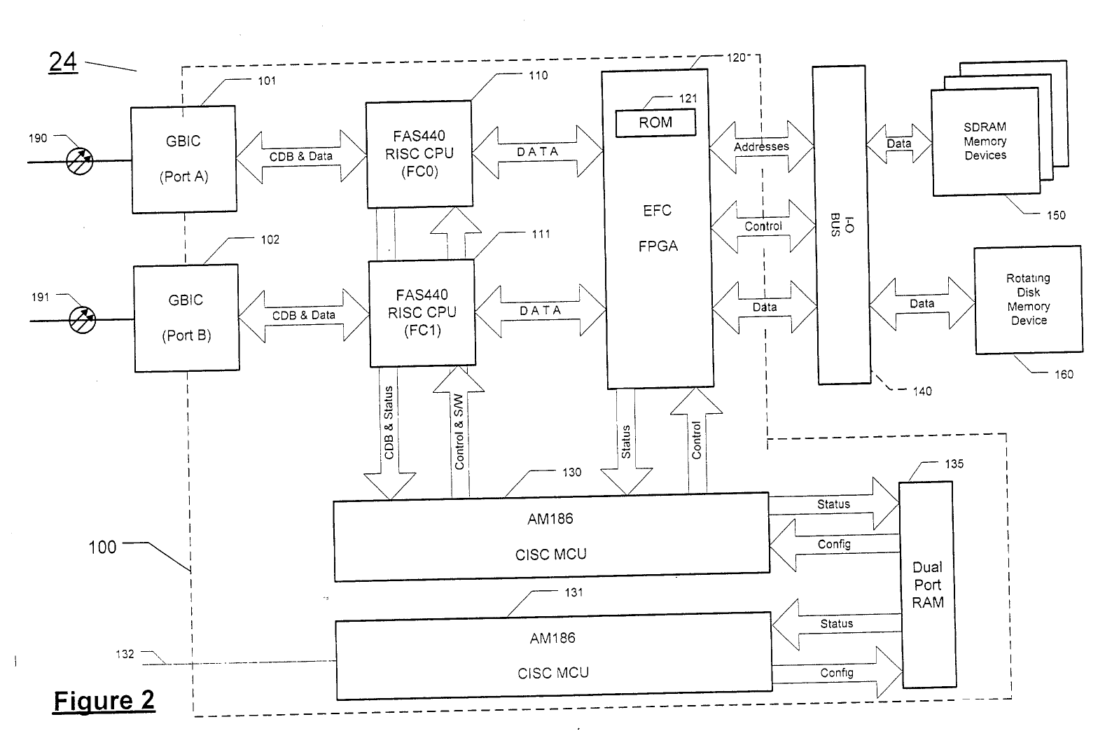

FIG. 2 is a block diagram of a solid state file cache 24 such as may be used to implement procedures according to an embodiment of the present invention.

As shown in FIG. 2, a solid state file cache 24 may include a data controller 100 having one or more GBIC (Gigabit Interface Converter) circuits 101, 102 for communication using optical fiber links 190, 191 in compliance with a communication standard and protocol, for example, FCA. The various broad arrows in FIG. 2 represent data highways that may be implemented as multi-wire ports, interconnects and/or busses. The arrowheads indicate the direction of information flow along the data highways. As indicated, these data highways may carry Data, CDB (Command Descriptor Blocks), status information, control information, addresses and/or S/W (software images).

The data controller 100 may communicate with an I-O (input-output) bus 140 to read and/or write data onto a HD (hard disk or rotating disk memory device) 160 and an array of one or more semiconductor memories such as SDRAMs (Synchronous Dynamic Random-Access Memories) 150. The SDRAMs 150 may typically be energized by batteries (electro-chemical cells, not shown in FIG. 2) so as to provide non-volatile memory storage up to the life of the batteries. The HD 160 may be interfaced using physical SCSI (Small Computer System Interface) and may be used to provide long term memory backup for indefinitely long periods, such as in the event of exhaustion or failure of the batteries.

Still referring to FIG. 2, data controller 100 may include one or more FCC ICs (Fibre-Channel controller integrated circuits) 110, 111 such as the FibreFAS440™ device from Qlogic® Corp. FibreFAS440 devices include a RISC CPU (reduced instruction set computer processing unit). As is well known, RISC CPUs are well adapted to data-oriented computing tasks of relative simplicity but requiring very high speed. In the data controller 100, the program instructions, sometimes called microcode, may be downloaded from a CISC MCU (complex instruction set microcontroller) 130 such as the AM186 device from Applied Micro Devices® Inc.

As contrasted with RISC devices, CISC devices are slower, have a richer instruction set and support much larger memory address spaces of a more complex nature. They are well suited for use in implementing complex tasks that do not require the great achievable speed. The solid state file cache 24 may include a second CISC MPU 131 which may communicate with the first CISC MPU 130 via a dual ported RAM (random-access memory) 135. CISC MPU 131 may provide for remote configuration management, monitoring and status reporting (RCM, RMR) and the like via an optional external interface (132) such as may be implemented using Ethernet, USB (universal serial bus) or EIA-232 (an Electronic Industry Association standard).

Still referring to FIG. 2, data controller 100 may further include a FPGA (field-programmable gate array) 120 for moving data in a controlled manner between FCC ICs 110, 111 and I-O bus 140. As depicted, FPGA 120 may include a ROM (read-only memory) 121 to direct its operation.

Referring again to FIG. 2, some aspects of operation of the solid state file cache 24 will now be described at a higher level. The second GBIC port 102 is optional and need not be used even if present. Optical fiber link 190 comprises two fibers, one each for transmit and receive on a FCA loop (not shown in FIG. 2). An information frame may enter GBIC 101 from fiber link 190 and the contents of the information frame may be passed to FCC IC 110. FCC IC 110 includes a RISC CPU which executes a software program or microprogram that may analyze the contents of information frames and take one of at least three possible courses of action. If the information frame is addressed to another node on the FCA loop, then it may be re-propagated onto the outgoing side of optical fiber link 190 such as by a daisy chaining process.

Although the FCA protocol provides for many types of information frame, representative types are designated in the FCA protocol as Primitives and may include user data to be written to storage, a request for user data to be read from storage or a Primitive relating to a type of CDB. In the solid state cache 24, CDB may be interpreted by the CISC MPU 130. CDBs for user data reads and writes may be handled by the FCC IC 110 by exchanging information with the FPGA 120 which in turn has access to the I-O bus 140 for reading and writing data. Other than for those implementing the simplest read and write commands, CDBs may be passed, in whole or in part, to the CISC MPU 130 which interprets those CDBs as commands under the control of software. Such CISC software (or firmware) is relatively much larger and feature rich than the very limited but much faster RISC control program(s) in the FCC IC 110.

An important Primitive in the FCA is the LIP (Loop Initialization Primitive) which is used to initiate a procedure of stabilizing an FCA loop under the arbitrated loop mode of FCA. Such initialization may typically occur either for the first time after power-up or because a node has entered or left the loop or possibly for other infrequent reasons. Loop initialization may involve multiple exchanges of information packets among the nodes on the loop and may be extensively directed by the CISC MPU 130. Only after completion of loop initialization that was initiated using a LIP is the number of nodes physically present on the FCA loop stable and known by all the control programs or equivalent in all the nodes. In some previously developed solutions, the software or microprogram in the FCC IC 110 was sufficiently flexible to be able to deal with an essentially open-ended (up to as many as the theoretical limit of 127) and from time to time variable number of nodes on the loop.

In an embodiment of the invention, upon completion of loop initialization, the CISC MPU 130 reloads and restarts the control program in the FCC IC 110. The version of control program reloaded into the FCC IC 110 may be selected by the CISC MPU 130 to be one that supports only the precise number and/or type of nodes configured by the loop initialization process. Thus, a version of RISC control that is optimized for the actual number of nodes determined to be present may be used in the RISC CPU of the FCC IC 110 without loss of generality as to the product in which the invention is embodied. The result is a superior overall system throughput and performance, especially as to user data reads and writes. Since user data reads and writes constitute an overwhelmingly high proportion of transactions over an extended period of time, any improvement in the performance thereof may be of major benefit to overall computer system performance.

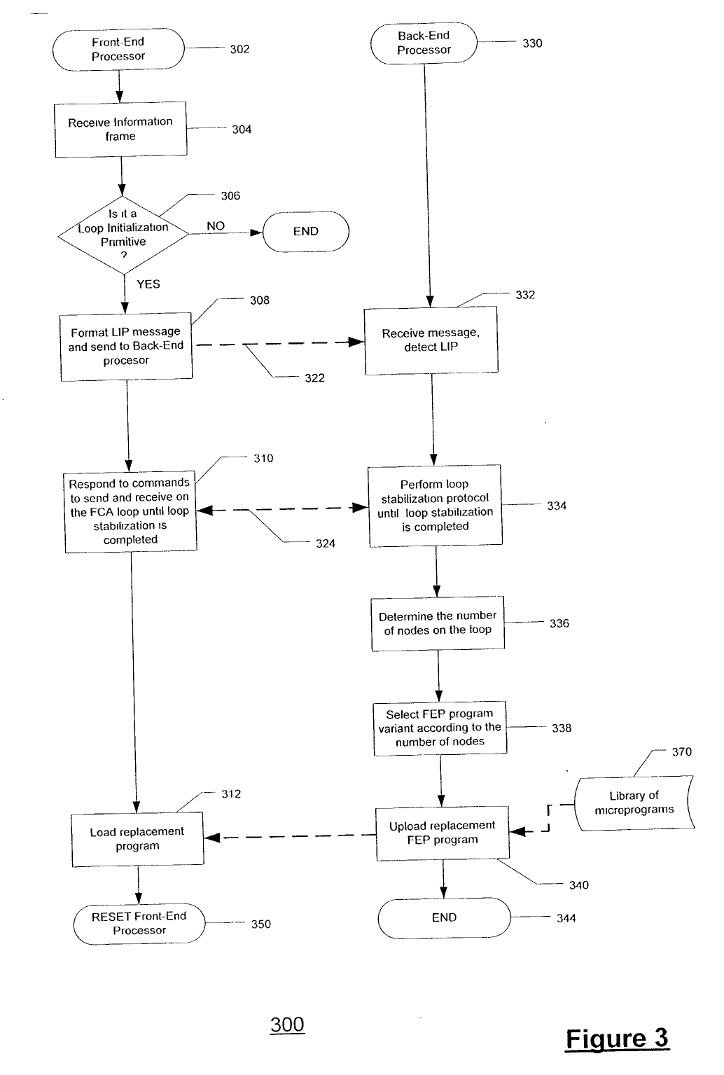

FIG. 3 shows an exemplary method 300 for initializing a data communications loop according to an aspect of the invention. However, the inventive method is not in general limited to the specific and exemplary components recited. The data communications loop may be a FCA loop configured according to the protocols applicable to FCA Arbitrated Loop topology. The method 300 shows two threads of execution. A first thread of execution 302 relates to a FEP (front-end processor) such as may be implemented by the FCC ID (110 of FIG. 2 and described above). A second thread of execution 330 relates to a BEP (back-end processor) such as may be implemented by CISC MPUs, also as described above.

In the FEP thread of execution 302, at box 304, an information frame is received from a GBIC. A determination is made in box 306 as to whether the information frame has a CDB containing a LIP, and if it does contain one, then in box 308 the CDB may be reformatted and sent to the BEP. Line 322 depicts transfer of information from FEP to BEP using IPC (interprocessor communication) techniques such as by way of the dual-port RAM of FIG. 2.

In the BEP thread of execution 330, in box 332, the information frame including CDB sent by the FEP is received by the BEP and the LIP is detected. The BEP may then, in box 334, perform a loop initialization and loop stabilization protocol according to the FCA standards for Arbitrated Loop topologies. This typically involves exchanging messages 324 to and from the FEP which in turn may, as depicted in box 310, respond to commands from and also to the frames bearing CDBs coming in via the GBIC, including sending and receiving on the FCA loop until loop stabilization is completed.

In box 336, when the BEP has completed loop stabilization it determines the number of Fibre Channel devices (nodes) on the FCA loop. Optionally the type of device may also be determined as this may also influence the choice of which version of RISC control program may be optimal. Next, in box 338, the BEP selects, creates, modifies or derives a variant of a control program for the FEP from a library of microprograms 370 and transfers a representation of the selected program variant to the FEP. The thread of the BEP is then complete 342. In box 312 the FEP thread of execution receives and loads the selected control program and then in box 350, when loading has been completed, the FEP resets itself to start execution of the newly loaded program, at which point the method is complete. In an alternative embodiment, the BEP may control restart and/or reset of the FEP directly such as through the use of control signal.

A brief description of loop initialization specific to the arbitrated loop topology within the FCA beginning with Loop Reset will now be described. At power up, or upon detecting loop instability (loss of synchronization), a device will transmit a frame containing a LIP CDB. Each device on the loop in turn will detect an incoming LIP and transmit a LIP from time to time until every device on the loop has detected an incoming LIP and the loop is reset.

Loop Master selection will now be described. Each device repeatedly transmits LISM (Loop Initialization Select Master) primitives. Upon receiving an incoming LISM, every device will either re-propagate the incoming LISM or substitute its own responsive to whether it has a numerically lower port name than the originator of the incoming LISM. Thus, the device having the lowest port name will receive its own LISM and become the loop master.

Assignment of AL_PA (arbitrated loop physical address) will now be described. The arbitrated loop topology allows for up to 127 devices. Each device is assigned a physical address during loop initialization. The loop master transmits a primitive including a 127-bit map; each device in turn may allocate itself a physical address by setting a bit in the bit map and then transmitting the modified frame. Four types of frames, known as LIFA, LIPA, LIHA and LISA, are originated by the loop master in sequence to permit a form of priority in AL_PA assignment.

Reporting position. Optionally, the master may circulate two further types of primitives, LIRP and LILP. Firstly, a LIRP may be used to enable the devices to report their sequential position on the loop and then an LILP may be used to report those positions to all devices that are interested in knowing positions. Position knowledge thus acquired may be used for performance optimization, especially if multiple loops are provided in a physical system.

As a final step in loop initialization, the loop master may send a frame including a CLS (Close) primitive so that each port may know that the loop has been initialized and is therefore ready for use to carry messages unrelated to initialization, for example, user data traffic.

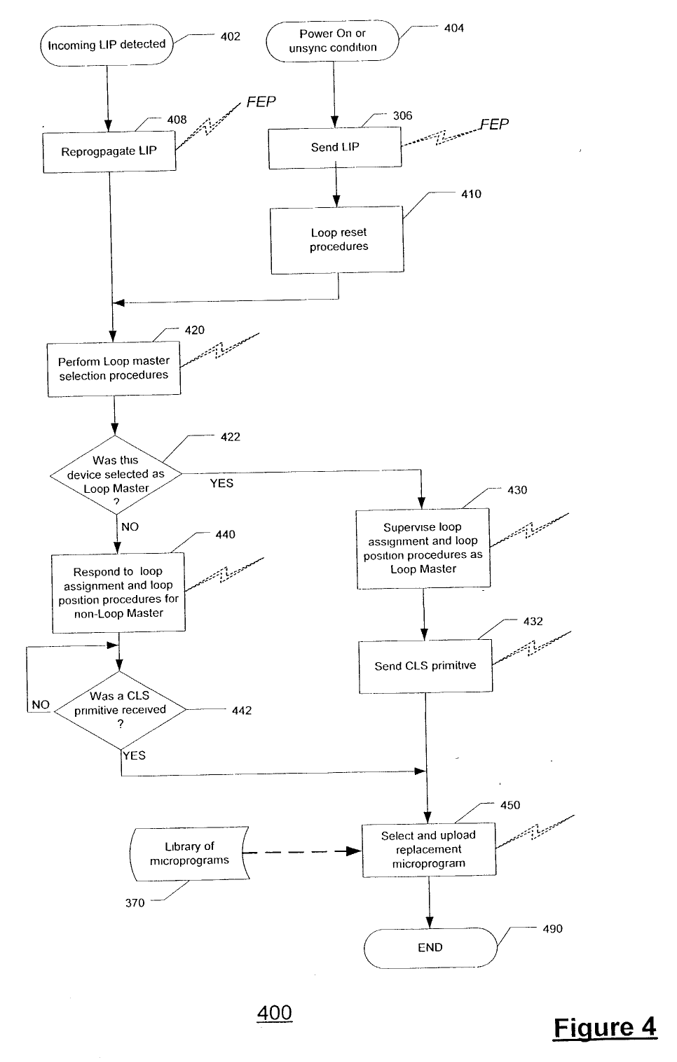

FIG. 4 shows an alternative exemplary method 400 for initializing a data communications loop according to an aspect of the invention. The data communications loop may be a FCA loop configured according to the protocols applicable to FCA Arbitrated Loop topology. The method 400 may be implemented in a BEP (back-end processor) such as 130 of FIG. 2. The method 400 shows two entry points.

A first entry point 404 occurs as a part of BEP power-up procedures or upon detection of loss of low level synchronization in the arbitrated loop. Loss of low level synchronization may indicate, for example, that a device (node) is leaving the loop, perhaps configured out by a physical loop hub. In either of these cases, it is necessary to generate a LIP to be transmitted so as to cause the loop to be reset. Thus, in box 406, the BEP sends a LIP. The sending of the LIP may involve such acts as formatting an information frame including a LIP CDB and passing that frame as a service request through interprocessor communication to the FEP, which further supervises arbitration of the communications loop, information transfer and notifying back to the BEP that the service request was honored.

An alternative entry point 402 occurs as a result of an incoming LIP being detected during normal operation of the BEP. At box 408, the LIP CDB is re-propagated to the next device on the loop. Thus, the LIP is propagated around the entire arbitrated loop and each device thereon becomes reset. After the re-propagation 408, control passes to box 420, discussed below.

Returning to the thread associated with the first entry point 404, at box 410 loop reset procedures are performed. This primarily involves monitoring incoming frames from the FEP until a CDB for a LIP is received. The frame contents may be examined to ensure that the LIP received is the consequence of the LIP originated having been propagated around the entire loop. Assuming that it is the “same” LIP returned from a trip around the loop, then loop reset is completed. However, a possibility exists that two (or more) devices on the loop initiated a reset procedure by sending a LIP simultaneously. For this reason, the loop reset procedure includes re-propagation of LIP initiated by another device. Eventually each initiating device will get its own LIP back and reset becomes completed in an orderly manner.

At box 420, selection of a loop master is performed. As described above, this involves transmission and receiving of LISM primitives, resulting deterministically in the selection of precisely one loop master. If the device is selected loop master (box 422) then control transfers to box 430. Otherwise the device is not the loop master and control passes to box 440.

In box 430 the device is Loop Master and so it initiates the cooperating procedures of the devices on the arbitrated loop that result in physical address assignment. As described above, the loop master device may now send in turn LIFA, LIPA, LIHA and LISA primitives. Each device on the loop generates a frame containing the same primitive as the one received so, in a sense, each primitive makes a trip around the loop and ends up back with the loop master. An optional phase may follow of loop position procedure which is a mapping of order on the loop to physical address is established and the reported to all devices on the loop. LIRP primitives are used to allow each device on the loop to report its relative physical position. Subsequently a LILP primitive may be used simply to allow all devices on the loop to be informed of the physical position of each of the other devices. This completes loop initialization for the loop master device and in box 432 a CLS (close) primitive is circulated to notify all the other devices that loop initialization is completed. Thereafter control passes to box 450.

The procedures of box 440 apply to devices on the arbitrated loop other than the loop master. The non-loop master device responds to any LIFA, LIPA, LIHA, LISA, LIRP or LILP primitives it receives and thereby acquires its own physical address and optionally loop order positions of all nodes. Re-propagation of a received CLS primitive terminates the protocol part of initialization and control passes to box 450.

In box 450 a microprogram for the FEP may be selected responsive to, primarily, the number of devices on the loop. However, other criteria such as whether or not the device is the loop master and the type of devices present may also be used. For example, some device may be better served with larger buffers allocated than other devices. The selected microprogram may be loaded from a library of microprograms 370 and uploaded to the FEP. Thus, the FEP becomes loaded with an executable image optimized for the loop configuration present, especially the number of devices on the loop.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for initializing a data communications loop comprising the acts of:
receiving, in a first processor, an information frame;
determining, by the first processor, that the information frame relates to a loop initialization primitive;
sending at least a part of the information frame to a second processor;
determining, by the second processor, a count of nodes on the data communications loop;
transferring, in response to the determining, from the second processor to the first processor, a program having an optimization specific to the count;
executing the program in the first processor.

2. The method of claim 1 wherein the data communications loop conforms to fibre-channel architecture for arbitrated loop topology.

3. The method of claim 1 further comprising executing, on the second processor at least a part of the a loop initialization protocol is response to the at least a part of the information frame.

4. The method of claim 1 wherein the first processor is a RISC and the second processor is a CISC.

5. The method of claim 1 wherein the information frame is a frame having a type selected from a list consisting of a Loop Initialization Report Position frame and a Loop Initialization Loop Position frame.

6. An apparatus connected to a data communications loop, the apparatus comprising:
a first processor and
a second processor;
the first processor having instructions operable to
receive an information frame,
determine that the information frame relates to a loop initialization primitive,
send at least a part of the information frame to the second processor and
execute a program transferred from the second processor,
the second processor having instructions operable to
determine a count of nodes on the data communications loop,
select the program from a plurality of programs, the program having an optimization specific to the count,
transfer the program from the second processor to the first processor.

7. A set of computer executable codes embodied on a computer-readable for initializing a data communications loop, the set of computer executable codes comprising:
instructions operable on a first processor to:
receive an information frame,
determine that the information frame relates to a loop initialization primitive,
send at least a part of the information frame to the second processor and
execute a program transferred from the second processor; and
instructions operable on a second processor to:
determine a count of nodes on the data communications loop,
select the program from a plurality of programs, the program having an optimization specific to the count, and
transfer the program from the second processor to the first processor.

8. A method for initializing a data communications loop comprising:
step for receiving, in a first processor, an information frame;
step for determining, by the first processor, that the information frame relates to a loop initialization primitive;
step for sending at least a part of the information frame to a second processor;
step for determining, by the second processor, a count of nodes on the data communications loop;
step for transferring, in response to the determining, from the second processor to the first processor, a program having an optimization specific to the count;
step for executing the program in the first processor.
